(19) United States
(12) Patent Application Publication
(10) Pub. No.: US 2025/0381867 A1
(43) Pub. Date: Dec. 18, 2025

(54) Apparatus for Equivalently Realizing Charging of Vehicle-Mounted Charger Based on Double-Winding Motor Control Topology

(71) Applicants: Zhejiang LeapPower Technology Co.,Ltd., Hangzhou, Zhejiang (CN); Zhejiang Leapmotor Technology Co.,Ltd, Hangzhou, Zhejiang (CN)

(72) Inventors: Feifan JI, Hangzhou, Zhejiang (CN); Xingcai CHEN, Hangzhou, Zhejiang (CN)

(73) Assignees: Zhejiang LeapPower Technology Co.,Ltd., Hangzhou, Zhejiang (CN); Zhejiang Leapmotor Technology Co.,Ltd, Hangzhou, Zhejiang (CN)

(21) Appl. No.: 18/877,868

(22) PCT Filed: Dec. 28, 2022
(86) PCT No.: PCT/CN2022/142745

§ 371 Date: Dec. 20, 2024

(30) Foreign Application Priority Data
Jul. 21, 2022 (CN) 202210856461.3

(51) Int. Cl. B60L 53/24; H02P 25/22; H02P 27/08

(52) U.S. Cl. CPC B60L 53/24; H02P 25/22; H02P 27/08; B60L 2210/40; B60L 2220/54

(57) ABSTRACT

An apparatus for equivalently realizing charging of a vehicle-mounted charger based on double-winding motor control topology is provided. The apparatus includes a switch assembly, a first-phase bridge arm, a second-phase bridge arm, a third-phase bridge arm, a fourth-phase bridge arm, and a capacitor. A first working mode and a second working mode are formed by controlling switch on and off of the switch assembly; the first working mode is a double-winding motor control mode, enable the first-phase bridge arm to be in a cutoff state, and the capacitor, the second-phase bridge arm, the third-phase bridge arm and the fourth-phase bridge arm form a first double-winding motor power control module.

### CROSS-REFERENCE TO RELATED APPLICATIONS

The present disclosure is a national stage application of International Patent Application NO. PCT/CN2022/142745, which is filed on Dec. 28, 2022, and claims priority to Chinese Patent Application No. 202210856461.3, filed on Jul. 21, 2022 and entitled “an apparatus for equivalently realizing charging of a vehicle-mounted charger based on double-winding motor control topology”, the contents of which are hereby incorporated by reference in its entirety.

### TECHNICAL FIELD

The present disclosure relates to the technical field of new energy cars, in particular to an apparatus for equivalently realizing charging of a vehicle-mounted charger based on double-winding motor control topology.

### BACKGROUND

Batteries are an important factor that restricts the development of electric cars. Compared with a lead-acid battery and a nickel battery, a lithium battery has the advantages of high energy density, long average service life, high working voltage and current of a single battery, high power density, no toxicity, low cost and the like, and is widely used in the field of electric cars. A common concern for a user of the electric car today is the problem of battery charging.

A charging pile is a non-vehicle-mounted charging device, which is generally installed in a fixed operation place, can directly provide direct-current voltage to a battery pack of the electric car, and has the advantages of high charging power and high charging speed. However, the charging place is fixed, and the portability is not good enough, compared with the charging pile, a vehicle-mounted charger can provide a more convenient charging method.

Due to limited space in a car, the vehicle-mounted charger is required to have small volume and weight, and also required to have high charging efficiency from the viewpoint of the user. Meanwhile, reducing hardware cost as much as possible is also an important problem for research and development personnel while functional requirements of the user are met.

At present, the vehicle-mounted charger is required to be added to hardware configuration of the electric car as a module independently, and relevant optimization and improvement solutions are also studied for the module as a whole. Based thereupon, in view of the above discussion, it is expected to obtain a novel alternative solution of the vehicle-mounted charger, with which charging efficiency can be improved as much as possible while space limitation of the electric car is effectively solved and overall hardware cost is reduced.

For example, Chinese patent CN202110732515.0 discloses a vehicle-mounted integrated charger driving circuit based on a dual three-phase permanent magnet synchronous motor driving system, the system works in multiple functional modes including electric driving, charging, V2G, and the like, and an electric driving large-rating inverter and a motor winding can be reused without adding other devices, so the cost is reduced. However, the technical solution of this patent is low in charging efficiency and high in heating amount.

### SUMMARY

Mainly aiming at the problem that in the relevant art, the vehicle-mounted charger needs to be disposed independently, so that the occupied space is large, and the charging efficiency is low. The present disclosure provides an apparatus for equivalently realizing charging of a vehicle-mounted charger based on double-winding motor control topology, in which functional requirements of double-winding motor control and vehicle-mounted charger charging are realized by reusing one set of hardware device, so that considerable cost advantage is realized while space of the device is saved, and better charging efficiency is realized.

The above technical problem of the present disclosure is solved through the following technical solution: an apparatus for equivalently realizing charging of a vehicle-mounted charger based on double-winding motor control topology includes a battery module, a switch assembly, a first-phase bridge arm, a second-phase bridge arm, a third-phase bridge arm, a fourth-phase bridge arm, a fifth-phase bridge arm, a sixth-phase bridge arm, a seventh-phase bridge arm, a capacitor C1, a capacitor C2, a first winding, a second winding, a third winding, a fourth winding, a fifth winding and a sixth winding. A first working mode and a second working mode are formed by controlling switch on and off of the switch assembly. The first working mode is a double-winding motor control mode, the switch assembly is controlled to enable the first-phase bridge arm to be in a cutoff state, the capacitor C1, the second-phase bridge arm, the third-phase bridge arm and the fourth-phase bridge arm form a first double-winding motor power control module, the first winding, the second winding and the third winding form a first double-winding motor winding module, the capacitor C2, the fifth-phase bridge arm, the sixth-phase bridge arm and the seventh-phase bridge arm form a second double-winding motor power control module, the fourth winding, the fifth winding and the sixth winding form a second double-winding motor winding module, under the double-winding motor control mode, the battery module outputs electricity supply power to the first double-winding motor power control module and the second double-winding motor power control module, the first double-winding motor power control module outputs a PWM signal to the first double-winding motor winding module, and the first double-winding motor winding module drives a motor to work; and the second double-winding motor power control module outputs a PWM signal to the second double-winding motor winding module, and the second double-winding motor winding module drives the motor to work. The second working mode is a vehicle-mounted charger charging mode, the switch assembly is controlled to enable one end of the first winding and a midpoint of the first-phase bridge arm to be connected with two ends of mains supply, the first-phase bridge arm, the second-phase bridge arm and the capacitor C1 form a PFC inverter circuit module, the third-phase bridge arm and the fourth-phase bridge arm form an inverter module, the second winding, the third winding, the fifth winding and the sixth winding form an isolation transformer module, the sixth-phase bridge arm, the seventh-phase bridge arm and the capacitor C2 form a rectifier module, the fifth-phase bridge arm is in a cutoff state, under the vehicle-mounted charger charging mode, mains supply is input to the PFC inverter circuit module and is input to the inverter module after being subjected to power correction by the PFC inverter circuit module, direct current is converted to alternating current which is input to the isolation transformer module for boost, current after boost is input to the rectifier module, and alternating current is converted to direct current for charging the battery module.

In some embodiments, the switch assembly includes a relay K1, a relay K2, a relay K3, a relay K4, a relay K5 and a relay K6, under the double-winding motor control mode, the relay K1, the relay K2, the relay K5 and the relay K6 are controlled to be switched on, and the relay K3 and the relay K4 are controlled to be switched off; and under the vehicle-mounted charger charging mode, the relay K1, the relay K2, the relay K5 and the relay K6 are controlled to be switched off, and the relay K3 and the relay K4 are controlled to be switched on.

In some embodiments, the second winding and the third winding are connected in series to form a primary side of the isolation transformer, and the fifth winding and the sixth winding are connected in series to form a secondary side of the isolation transformer.

In some embodiments, the first winding, the second winding and the third winding are symmetric windings, and form the first double-winding motor winding module by star connection.

In some embodiments, the fourth winding, the fifth winding and the sixth winding are symmetric windings, and form the second double-winding motor winding module by star connection.

In some embodiments, by disposing the relay K5 between the first winding and a star connection midpoint of the first double-winding motor winding module and the relay K6 between a midpoint of the fifth-phase bridge arm and the fourth winding, by controlling switch on and off of the relay K5 and the relay K6, structure switch between the first double-winding motor winding module under the double-winding motor control mode and an isolation transformer formed by series connection of windings under the vehicle-mounted charger charging mode is realized.

In some embodiments, the relay K3 is disposed between the midpoint of the first-phase bridge arm and an L end of mains supply, the relay K4 is disposed between the first winding and an N end of mains supply, the relay K4 and the relay K5 form a double-pole double-throw switch, and alternating-current power input of mains supply under the vehicle-mounted charger charging mode is realized by controlling switch on of the relay K5 and the relay K6.

In some embodiments, electrical resistance characteristics of the first winding, the second winding and the third winding are the same.

In some embodiments, electrical resistance characteristics of the fourth winding, the fifth winding and the sixth winding are the same.

The present disclosure has the beneficial effects that: (1) the vehicle-mounted charger does not need to be regarded as an independent module any more, but hardware topology under double-winding motor control is reused to a large extent to realize one-topology two functions; (2) a device for double-winding motor control topology is reused for realizing vehicle-mounted charging, so that the charging efficiency can be effectively improved; (3) only a small number of power switch devices and relay devices are introduced in the process of hardware transformation, the functions of double-winding motor control and vehicle-mounted charger charging are realized at the same time, so that the cost is greatly reduced in the whole, meanwhile, the two functions are independent from each other, the complexity of actual control is not increased, the structure is simple, and the cost is low.

### BRIEF DESCRIPTION OF THE DRAWINGS

FIG. 1 illustrates a schematic structure diagram of topology under a double-winding motor control mode according to an embodiment of the present disclosure.

FIG. 2 illustrates a schematic structure diagram of topology under a vehicle-mounted charger charging mode according to an embodiment of the present disclosure.

FIG. 3 illustrates a schematic diagram of relay control operation condition for switch between a double-winding motor control mode and a vehicle-mounted charger charging mode according to an embodiment of the present disclosure.

### DETAILED DESCRIPTION OF THE EMBODIMENTS

The implementation modes of the present disclosure will be described below with reference to specific examples, and other advantages and effects of the present disclosure will be readily apparent to those skilled in the art from what is disclosed in this specification. The present disclosure can also be implemented or applied in other different specific implementation modes, the details in the specification can also be modified or changed based on different points of view and applications without deviating from the spirit of the present disclosure. It is to be noted that the embodiments and features in the embodiments below can be combined with each other without conflict.

In order to make the purpose, technical solutions and advantages of the present disclosure clearer, the technical solutions in the embodiments of the present disclosure will be further described in detail below in combination with the drawings and embodiments. It is to be understood that the specific embodiments described herein are for the purpose of explaining the present disclosure only and are not intended to limit the present disclosure.

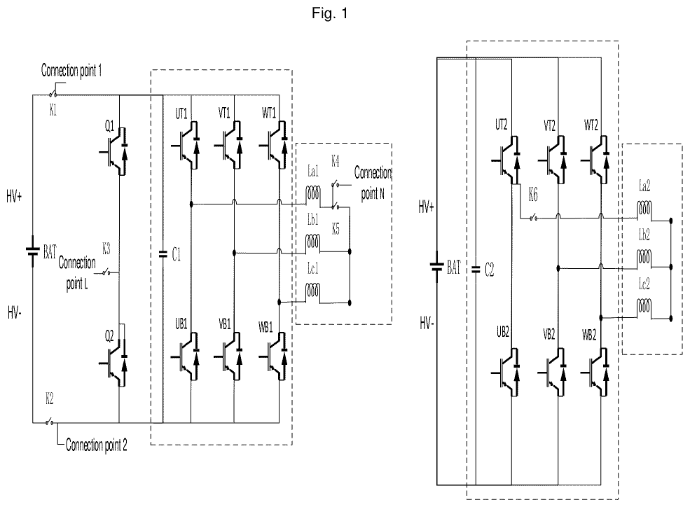

Embodiment: An apparatus for equivalently realizing charging of a vehicle-mounted charger based on double-winding motor control topology, as shown in FIG. 1, a structure under a double-winding motor control mode includes a battery module, a first double-winding motor power control module, a first double-winding motor winding module, a second double-winding motor power control module and a second double-winding motor winding module.

For the battery module, the positive and negative electrodes of a battery respectively communicate with a connection point 1 and a connection point 2, respectively leading to two paths, which are respectively connected with upper and lower ends of the first double-winding motor power control module and the second double-winding motor power control module, and at the same time provide direct-current voltage for two paths of three-phase inverter circuits. For one path, a pair of upper bridge arm Q1 and lower bridge arm Q2 is connected between the battery in the module and a capacitor C1 in the first double-winding motor power control module in parallel, and each of the two bridge arms is formed by connecting a power switch tube and a free-wheeling diode. A relay K1 is configured in a path connected with the upper end of the bridge arm Q1, and the connection point 1 is introduced. A relay K2 is configured in a path connected with the lower end of the bridge arm Q2, and the connection point 2 is introduced. A relay K3 is introduced at a connection midpoint of the upper and lower bridge arms Q1 and Q2, a connection point L is introduced, and the connection point L is connected with an L end of a mains supply module. No related power devices and relay switch devices are additionally configured for the other path. Under the double-winding motor control mode, the relay K1 and the relay K2 are controlled to be switched on, the relay K3 is controlled to be switched off, the bridge arm Q1 and the bridge arm Q2 are enabled to be in a cutoff state, the bridge arm Q1 and the bridge arm Q2 form a first-phase bridge arm, and under the mode, the bridge arm Q1 and the bridge arm Q2 are slightly redundant, but are indispensable structures in the vehicle-mounted charger charging mode.

The first double-winding motor power control module is composed of a capacitor C1 and three phases of bridge arms, the upper and lower ends of the capacitor C1 are connected with upper and lower ends of the bridge arm of the three-phase inverter circuit, including a second-phase bridge arm, a third-phase bridge arm and a fourth-phase bridge arm, each phase includes an upper bridge arm and a lower bridge arm, each bridge arm is formed by connecting a power switch tube and a free-wheeling diode. A basic block UT1 serves as the upper bridge arm of the first-phase bridge arm, a basic block UB1 serves as the lower bridge arm of the first-phase bridge arm, the two blocks are connected, and the midpoint of the bridge arm is connected with a first winding La1 of the first double-winding motor winding module. A basic block VT1 serves as the upper bridge arm of the second-phase bridge arm, a basic block VB1 serves as the lower bridge arm of the second-phase bridge arm, the two blocks are connected, and the midpoint of the bridge arm is connected with a second winding Lb1 of the first double-winding motor winding module. A basic block WT1 serves as the upper bridge arm of the third-phase bridge arm, a basic block WB1 serves as the lower bridge arm of the third-phase bridge arm, the two blocks are connected, the midpoint of the bridge arm is connected with a third winding Lc1 of the first double-winding motor winding module. The midpoint of the three phases of bridge arms is connected with three phases of windings of the first double-winding motor winding module, and by controlling a gate signal of the power tube of each bridge arm, the first double-winding motor power control module outputs PWM wave to drive the first double-winding motor winding module.

The first double-winding motor winding module is formed by star connection of three phases of symmetric windings including the first winding La1, the second winding Lb1 and the third winding Lc1. Electrical resistance characteristics of the first winding La1, the second winding Lb1 and the third winding Lc1 are the same. A double-pole double-throw switch is configured in a link connecting the first winding La1 and the star midpoint. The relay K5 controls connection of the first winding La1 and the star midpoint, the relay K4 controls connection of the first winding La1 and the connection point N, the connection point N is connected with the N end of the mains supply module. The relay K4 is switched off, and the relay K5 is switched on to ensure normal operation of the winding module under the motor driving mode.

The second double-winding motor power control module is composed of a capacitor C2 and three phases of bridge arms, including a fifth-phase bridge arm, a sixth-phase bridge arm and a seventh-phase bridge arm, each phase includes an upper bridge arm and a lower bridge arm, each bridge arm is formed by connecting a power switch tube and a free-wheeling diode. The basic block UT2 serves as the upper bridge arm of the fifth-phase bridge arm, the basic block UB2 serves as the lower bridge arm of the fifth-phase bridge arm, and the two blocks are connected, the midpoint of the bridge arm is connected with the fourth winding La2 of the second double-winding motor winding module, and a relay K6 is configured in the path. A basic block VT2 serves as the upper bridge arm of the sixth-phase bridge arm, a basic block VB2 serves as the lower bridge arm of the sixth-phase bridge arm, the two blocks are connected, and the midpoint of the bridge arm is connected with a fifth winding Lb2 of the second double-winding motor winding module. A basic block WT2 serves as the upper bridge arm of the seventh-phase bridge arm, a basic block WB2 serves as the lower bridge arm of the seventh-phase bridge arm, the two blocks are connected, the midpoint of the bridge arm is connected with a sixth winding Lc2 of the second double-winding motor winding module. The relay K6 is controlled to be switched on, the midpoint of the three phases of bridge arms is connected to three phases of windings of the second double-winding motor winding module, by controlling a gate signal of the power tube of each bridge arm, the second double-winding motor power control module outputs PWM wave to drive the second double-winding motor winding module.

The second double-winding motor winding module is formed by star connection of three phases of symmetric windings, including a fourth winding La2, a fifth winding Lb2 and a sixth winding Lc2. Electrical resistance characteristics of the fourth winding La2, the fifth winding Lb2 and the sixth winding Lc2 are the same. The second double-winding motor winding module is controlled by PWM emitted from the second double-winding motor power control module.

Under the double-winding motor control mode, the battery module controls the first double-winding motor winding module and the second double-winding motor winding module simultaneously but individually through the first double-winding motor power control module and the second double-winding motor power control module.

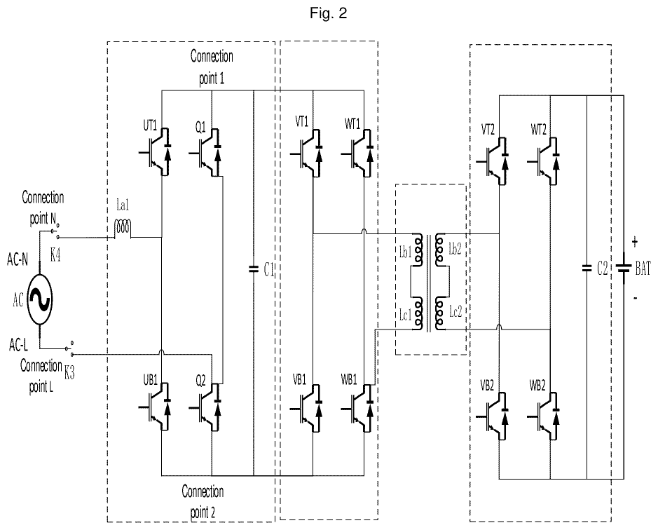

FIG. 2 is a structure under the vehicle-mounted charger charging mode of the present disclosure, including a mains supply module, a PFC inverter circuit module, an inverter module, an isolation transformer module, a rectifier module and a battery module.

For the mains supply module, under the vehicle-mounted charger charging mode, the relays K3 and K4 are controlled to be switched on, the relays K1 and K2 are switched off, the N end of mains supply communicates with the connection point N, the L end of the mains supply communicates with the connection point L, and power transmission to the PFC inverter circuit is realized.

For the PFC inverter circuit module, the relay K5 is controlled to be switched off, so that the first winding La1 separates from star connection under the motor control mode, and is placed in the PFC inverter circuit module as an independent resistance component. The bridge arm Q1 and the bridge arm Q2 are switched from a cutoff state under the double-winding motor control mode to an enable state, the bridge arm UT1, the bridge arm UB1, the bridge arm Q1 and the bridge arm Q2 form two phases of bridge arms together, the upper and lower ends are connected with the capacitor C1 in parallel at the same time, and the switch on and off of each bridge arm is controlled by its gate signal, for realizing inverter boost of the PFC.

For the inverter module, the bridge arm VT1, the bridge arm VB1, the bridge arm WT1 and the bridge arm WB1 form two phases of bridge arms together, the inversion function is realized by controlling a gate signal of each power switch tube, and high-frequency alternating voltage is output.

For the isolation transformer module, the relay K5 and the relay K6 are controlled to be switched off to enable the first winding La1 and the fourth winding La2 to separate from star connection under the motor control mode, the second winding Lb1 and the third winding Lc1 are automatically connected in series to form a primary side of a transformer, the fifth winding Lb2 and the sixth winding Lc2 are automatically connected in series to form a secondary side of the transformer. By reasonably configuring the number of turns of the two windings, the function of transformation of the isolation transformer can be realized. The number of turns of three phases of windings in the first double-winding motor winding module is different from that in the second double-winding motor winding module, for controlling the turns ratio of the primary side to the secondary side of the isolation transformer module under switching to the vehicle-mounted charger charging mode, the boost function of the module is realized. The number of turns of the winding is reasonably configured according to actual demands, and the boost demand of the isolation transformer module is realized.

For the rectifier module, the bridge arm VT2, the bridge arm VB2, the bridge arm WT2 and the bridge arm WB2 form two phases of bridge arms together, upper and lower ends of the two phases of bridge arms are connected with two ends of the capacitor C2 respectively. The rectification function is realized by controlling a gate signal of each power switch tube, and direct-current charging voltage is output for charging the battery.

For the battery module, in such a case, the relay K1 and the relay K2 are controlled to be switched off. The battery is only connected with the rectifier module in structure, receiving its output electric power for charging.

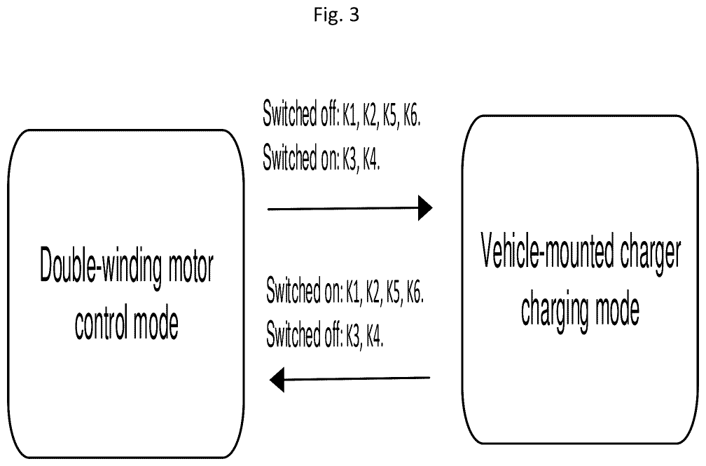

To sum up, the mode switch condition of the double-winding motor control mode and the vehicle-mounted charger charging mode is shown in FIG. 3. Under the vehicle-mounted charger charging mode, the relay K1, the relay K2, the relay K5 and the relay K6 are controlled to be switched off, and the relay K3 and the relay K4 are controlled to be switched on. Under the double-winding motor control mode, the relay K1, the relay K2, the relay K5 and the relay K6 are controlled to be switched on, and the relay K3 and the relay K4 are controlled to be switched off.

In the topology structure of the present disclosure, all power switch tubes and relay switches related can be replaced by any device with similar switching characteristics.

The above embodiment is only a preferred solution of the present disclosure and is not a limitation of the present disclosure in any form, and there are also other variations and modifications on the premise of not exceeding the technical solution described in the claims.

1. An apparatus for equivalently realizing charging of a vehicle-mounted charger based on double-winding motor control topology, comprising:
a battery module, a switch assembly, a first-phase bridge arm, a second-phase bridge arm, a third-phase bridge arm, a fourth-phase bridge arm, a fifth-phase bridge arm, a sixth-phase bridge arm, a seventh-phase bridge arm, a capacitor C1, a capacitor C2, a first winding, a second winding, a third winding, a fourth winding, a fifth winding and a sixth winding; a first working mode and a second working mode are formed by controlling switch on and off of the switch assembly;
the first working mode is a double-winding motor control mode, the switch assembly is controlled to enable the first-phase bridge arm to be in a cutoff state, the capacitor C1, the second-phase bridge arm, the third-phase bridge arm and the fourth-phase bridge arm form a first double-winding motor power control module, the first winding, the second winding and the third winding form a first double-winding motor winding module, the capacitor C2, the fifth-phase bridge arm, the sixth-phase bridge arm and the seventh-phase bridge arm form a second double-winding motor power control module, the fourth winding, the fifth winding and the sixth winding form a second double-winding motor winding module, under the double-winding motor control mode, the battery module outputs electricity supply power to the first double-winding motor power control module and the second double-winding motor power control module, the first double-winding motor power control module outputs a PWM signal to the first double-winding motor winding module, and the first double-winding motor winding module drives a motor to work; the second double-winding motor power control module outputs a PWM signal to the second double-winding motor winding module, and the second double-winding motor winding module drives the motor to work;
the second working mode is a vehicle-mounted charger charging mode, the switch assembly is controlled to enable an end of the first winding and a midpoint of the first-phase bridge arm to be connected with two ends of mains supply, the first-phase bridge arm, the second-phase bridge arm and the capacitor C1 form a PFC inverter circuit module, the third-phase bridge arm and the fourth-phase bridge arm form an inverter module, the second winding, the third winding, the fifth winding and the sixth winding form an isolation transformer module, the sixth-phase bridge arm, the seventh-phase bridge arm and the capacitor C2 form a rectifier module, the fifth-phase bridge arm is in a cutoff state, under the vehicle-mounted charger charging mode, mains supply is input to the PFC inverter circuit module and is input to the inverter module after being subjected to power correction by the PFC inverter circuit module, direct current is converted to alternating current which is input to the isolation transformer module for boost, current after boost is input to the rectifier module, and alternating current is converted to direct current for charging the battery module.

2. The apparatus for equivalently realizing charging of a vehicle-mounted charger based on double-winding motor control topology as claimed in claim 1, wherein
the switch assembly comprises a relay K1, a relay K2, a relay K3, a relay K4, a relay K5 and a relay K6, under the double-winding motor control mode, the relay K1, the relay K2, the relay K5 and the relay K6 are controlled to be switched on, and the relay K3 and the relay K4 are controlled to be switched off;
under the vehicle-mounted charger charging mode, the relay K1, the relay K2, the relay K5 and the relay K6 are controlled to be switched off, and the relay K3 and the relay K4 are controlled to be switched on.

3. The apparatus for equivalently realizing charging of a vehicle-mounted charger based on double-winding motor control topology as claimed in claim 1, wherein
the second winding and the third winding are connected in series to form a primary side of an isolation transformer, and the fifth winding and the sixth winding are connected in series to form a secondary side of the isolation transformer.

4. The apparatus for equivalently realizing charging of a vehicle-mounted charger based on double-winding motor control topology as claimed in claim 2, wherein
the first winding, the second winding and the third winding are symmetric windings, and form the first double-winding motor winding module by star connection.

5. The apparatus for equivalently realizing charging of a vehicle-mounted charger based on double-winding motor control topology as claimed in claim 4, wherein
the fourth winding, the fifth winding and the sixth winding are symmetric windings, and form the second double-winding motor winding module by star connection.

6. The apparatus for equivalently realizing charging of a vehicle-mounted charger based on double-winding motor control topology as claimed in claim 5, wherein
by disposing the relay K5 between the first winding and a star connection midpoint of the first double-winding motor winding module and the relay K6 between a midpoint of the fifth-phase bridge arm and the fourth winding, by controlling switch on and off of the relay K5 and the relay K6, structure switch between the first double-winding motor winding module under the double-winding motor control mode and an isolation transformer formed by series connection of windings under the vehicle-mounted charger charging mode is realized.

7. The apparatus for equivalently realizing charging of a vehicle-mounted charger based on double-winding motor control topology as claimed in claim 2, wherein
the relay K3 is disposed between the midpoint of the first-phase bridge arm and an L end of mains supply, the relay K4 is disposed between the first winding and an N end of mains supply, the relay K4 and the relay K5 form a double-pole double-throw switch, and alternating-current power input of mains supply under the vehicle-mounted charger charging mode is realized by controlling switch on of the relay K5 and the relay K6.

8. The apparatus for equivalently realizing charging of a vehicle-mounted charger based on double-winding motor control topology as claimed in claim 1, wherein
electrical resistance characteristics of the first winding, the second winding and the third winding are the same.

9. The apparatus for equivalently realizing charging of a vehicle-mounted charger based on double-winding motor control topology as claimed in claim 1, wherein
electrical resistance characteristics of the fourth winding, the fifth winding and the sixth winding are the same.

10. The apparatus for equivalently realizing charging of a vehicle-mounted charger based on double-winding motor control topology as claimed in claim 2, wherein
the second winding and the third winding are connected in series to form a primary side of an isolation transformer, and the fifth winding and the sixth winding are connected in series to form a secondary side of the isolation transformer.
